(19) United States
(12) Patent Application Publication
(10) Pub. No.: US 2023/0147553 A1
(43) Pub. Date: May 11, 2023

(54) PROCESSING BUILD MATERIAL

(71) Applicant: Hewlett-Packard Development Company, L.P., Spring, TX (US)

(72) Inventors: Esteve COMAS CESPEDES, Sant Cugat del Valles (ES); Michel Georges ENCRENAZ, Sant Cugat del Valles (ES); Sergi CULUBRET CORTADA, Sant Cugat del Valles (ES); Davinia FONT CALAFELL, Sant Cugat del Valles (ES); Luis GARCIA GARCIA, Sant Cugat del Valles (ES)

(73) Assignee: Hewlett-Packard Development Company, L.P., Spring, TX (US)

(21) Appl. No.: 17/794,933

(22) PCT Filed: Apr. 30, 2020
(86) PCT No.: PCT/US2020/030598

§ 371 Date: Jul. 22, 2022

(51) Int. Cl. B22F 12/70; B22F 10/16; B22F 10/322; B22F 12/13; B22F 12/20; B33Y 10/00; B33Y 30/00; B33Y 50/02; B29C 64/165; B29C 64/393; B29C 64/295; B29C 64/364

(52) U.S. Cl. CPC B22F 12/70; B22F 10/16; B22F 10/322; B22F 12/13; B22F 12/20; B33Y 10/00; B33Y 30/00; B33Y 50/02; B29C 64/165; B29C 64/393; B29C 64/295; B29C 64/364

(57) ABSTRACT

According to one example, there is provided an apparatus to process volume of particulate build material. The apparatus comprises a sealable chamber to house a volume of particulate build material, a gas supply to supply the chamber with a predetermined gas, a gas circulator to circulate the gas within the volume of build material, a temperature controller to heat the circulated gas to a predetermined heating temperature to heat the volume of build material to the heating temperature and then to cool the circulated gas to a predetermined cooling temperature to cool the volume of build material to the cooling temperature.

### BACKGROUND

Some three-dimensional printing systems form objects by selectively solidifying successively formed layers of a particulate build material formed on a build platform within a build chamber. Some three-dimensional printing systems apply liquid binder agent, for example from an ink-jet type printhead, to each layer of build material in a pattern corresponding to the cross-section of the object being formed. In some systems the binder agent has to be cured after it is applied to the build material to cause the binder agent to bind particles of the build material together in the desired shape. In other three-dimensional printing system objects may be generated by selectively melting portions of successively formed layers of a particulate build material, such as a powdered plastic build material, to form layers of the object.

### BRIEF DESCRIPTION

Examples will now be described, by way of non-limiting example only, with reference to the accompanying drawings, in which:

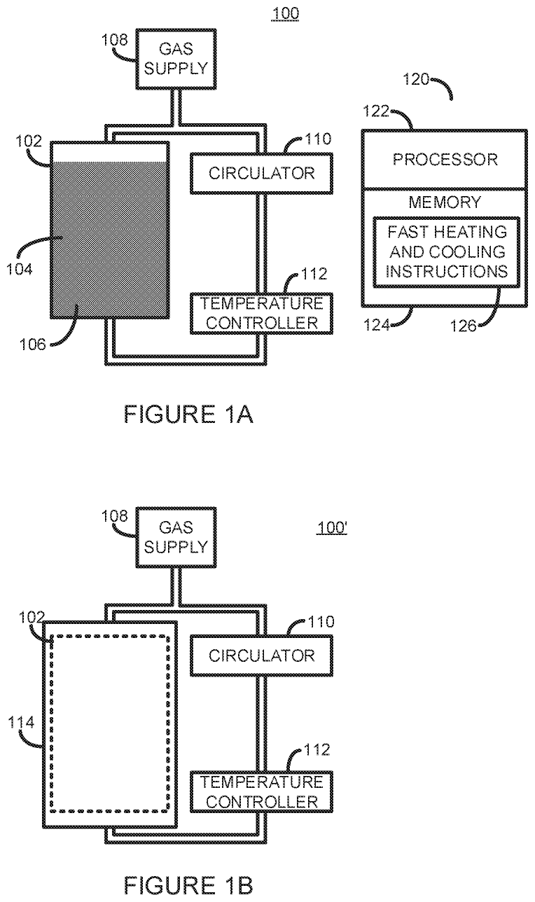

FIG. 1A is a simplified schematic diagram of a build material processing apparatus according to one example;

FIG. 1B is a simplified schematic diagram of a build material processing apparatus according to one example;

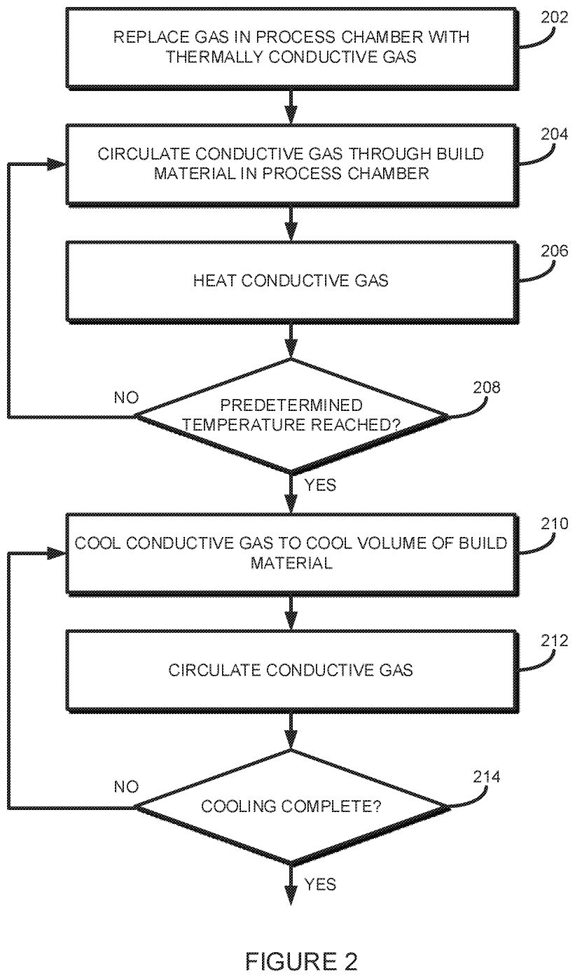

FIG. 2 is a flow diagram outlining a method of operating a build material processing apparatus according to one example;

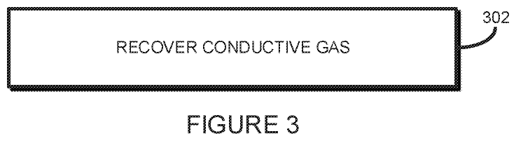

FIG. 3 is a flow diagram outlining a method of operating a build material processing apparatus according to one example;

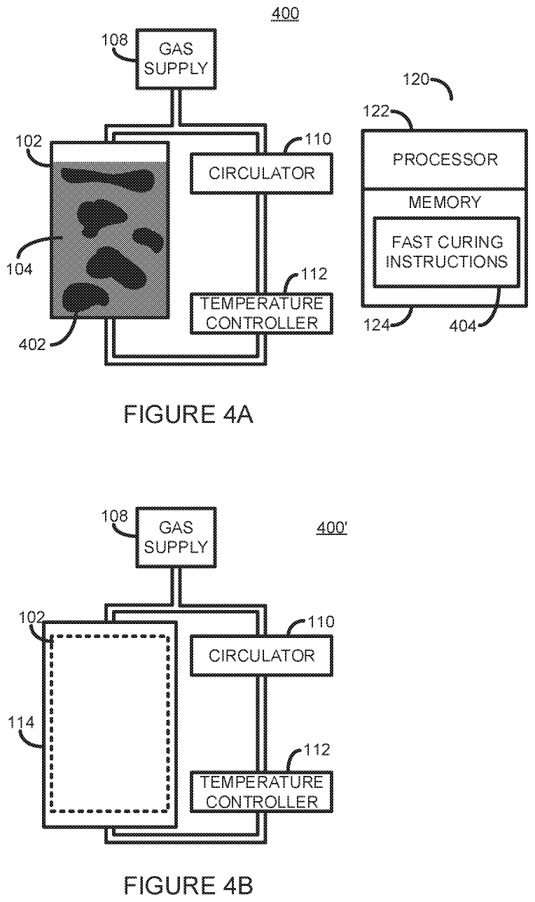

FIG. 4A is a simplified schematic diagram of a fast curing apparatus according to one example;

FIG. 4B is a simplified schematic diagram of a fast curing apparatus according to one example;

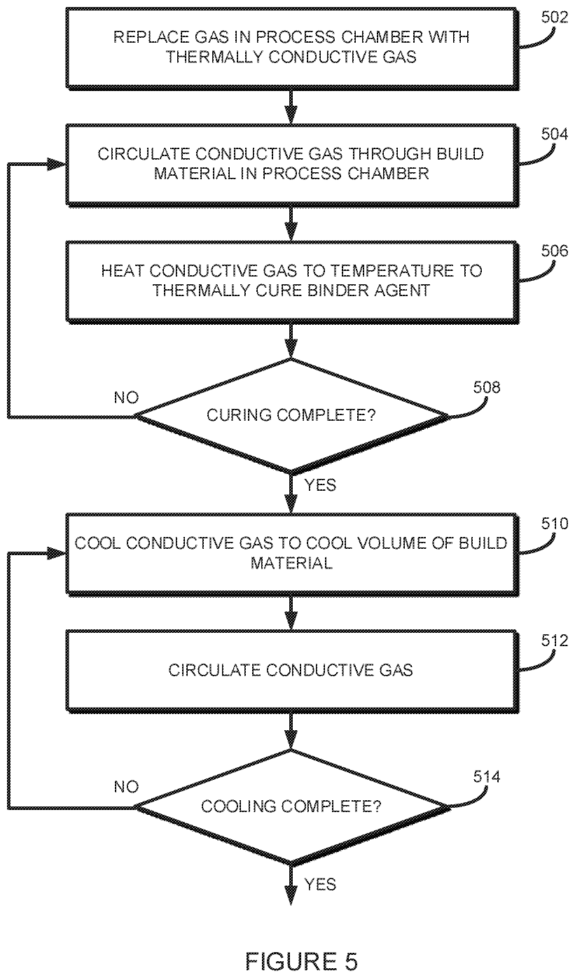

FIG. 5 is a flow diagram outlining a method of operating a fast curing apparatus according to one example;

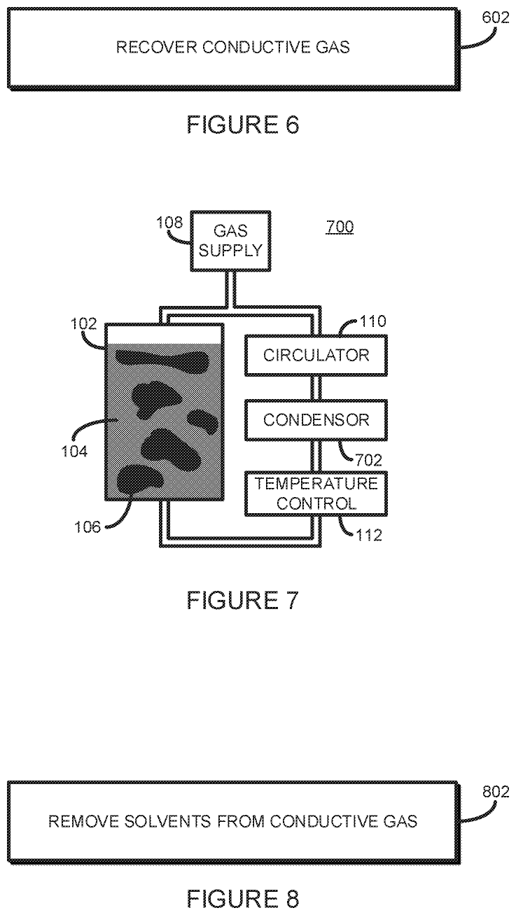

FIG. 6 is a flow diagram outlining a method of operating a fast curing apparatus according to one example;

FIG. 7 is a simplified schematic diagram of a fast curing apparatus according to one example; and

FIG. 8 is a flow diagram outlining a method of operating a fast curing apparatus according to one example.

### DETAILED DESCRIPTION

Some three-dimensional printing systems use a thermally curable binder agent which has to be heated to a predetermined temperature to cause components of the liquid binder agent to bind together particles of build material on which it is applied. Such a liquid binder agent may comprise latex particles and curing of the binder may occur, for example, at a temperature above 100 degrees Celsius, or above 120 degrees Celsius, or above 150 degrees Celsius.

Such binder agents may be applied to successive layers of powdered metal build material, such as powdered stainless steel (e.g. SS316L) build material, and the curing of the binder agent leads to the generation of so-called ‘green parts’. Green parts are generally relatively low-density objects formed by a matrix of metal build material particles and cured binder. Green parts are transformed into highly dense final objects by heating them in a sintering furnace to a temperature close to the melting point of the build material used.

When using thermally curable binder agents, it may be unsuitable to cure binder agent on a layer-by-layer basis within a three-dimensional printing system. This may be the case, for example, if the temperature at which the binder particles of the binder agent cure is higher than the boiling point of a binder agent liquid carrier vehicle. Accordingly, such systems may first apply binder agent to successively formed layers of build material on a build platform in a build chamber, and then may separately (and after completion of the printing of binder agent) heat the contents of the build chamber to cure the binder agent therein.

Typically, heating the contents of a build chamber is done using thermal blankets, such as resistive heaters, positioned around the perimeter of the build chamber. However, the time taken to heat the contents of a build chamber to thermally cure the binder agent therein may take many hours. One reason for this is that the thermal conductivity of a volume of build material is relatively low, making conductive heating somewhat inefficient. Furthermore, it may also take many hours for the contents of a build chamber to cool down after curing has taken place. For example, when using stainless steel powder, and a build chamber having dimensions of 30 cm×30 cm×30 cm, heating the contents of the build chamber to cure binder agent and cooling back to ambient temperature may take over 30 hours.

In three-dimensional printing system that melt selected regions of successive layers of a particulate build material to form layers of an object, it may be beneficial to heat the contents of the build chamber to a predetermined temperature for a predetermined period after generation of the object, for example to enable improved crystallization of melted build material particles to occur. Such a process may be referred to as annealing.

In other three-dimensional printing systems, it may be beneficial to condition a volume of build material before it is used in a three-dimensional printing process. Such build material conditioning may be achieved, for example, by heating the volume of build material to a predetermining temperature for a predetermined period, for example to allow build material to age, to stabilize, or the like.

However, heating a volume of three-dimensional build material to a predetermined temperature and then cooling it back down to ambient temperature (or another suitable cooled temperature) may be particularly time consuming. One reason for this is that a volume of build materials generally has a relatively low thermal conductivity. This may, for example, be because one or more of: the build material itself has a relatively low thermal conductivity; and the build material particles are not densely packed together and hence are mixed with a volume of air which itself has a relatively low thermal conductivity.

The value proposition of three-dimensional printing, however, increases significantly as the time to generate 3D objects is reduced.

Examples described herein relate to an apparatus and a method of increasing the throughput of three-dimensional printing systems by speeding up the thermal curing process, and also by speeding up the cooling process following the thermal curing process.

Referring now to FIG. 1 there is shown a simplified schematic diagram of an apparatus 100 to heat and then cool the contents of a container or a process chamber 102. The container or process chamber 102 may, when in use, comprise a volume of particulate build material 104, such as a metal, a ceramic, or a plastic, build material. In one example, the volume of build material 104 may be formed in the container 102 by a three-dimensional printer, and in another example the volume of build material 104 may be transferred into the container 102 from a build unit of a three-dimensional printer.

The apparatus 100 further comprises a gas supply 108 to supply a gas having a relatively higher thermal conductivity than air, for example a gas having a thermal conductivity greater than about 0.1 W/(m K). In one example, the gas supply 108 is a supply of helium gas, and in another example the gas supply 108 is a supply of sulfur hexafluoride gas. Hereinafter the gas supplied by the gas supply 108 will be referred to as the ‘conductive gas’. The gas supply 108 is to replace the gas initially present in the container or process chamber 102, such as air or an inert gas such as nitrogen or carbon dioxide, with the conductive gas from the gas supply 108. In one example, the gas supply 108 may also be used to recover the conductive gas to enable it to be reused. In one example the gas supply 108 comprises a supply of conductive gas, for example, in a pressurized canister. In one example the gas supply 108 may additionally comprise a compressor (not shown) to allow recovered conductive gas to be returned to the gas supply 108.

As illustrated in FIG. 1A, in the example shown the apparatus 100 further comprises a circulator 110, such as a fan, and a temperature controller 112. The temperature controller 112 comprises a heating module (not shown), such as a resistive heater, to heat the conductive gas to a predetermined temperature. The temperature to which the temperature controller is to heat the conductive gas may be, for example, in the range of about 40 degrees Celsius to about 300 degrees Celsius depending on the purpose of heating the build material 104. In other example a higher or lower temperature range may be suitable.

A top portion of the container or process chamber 102 is fluidically connected to the gas supply 108 and the circulator 110 by a set of conduits, the circulator 110 is fluidically connected to the temperature controller 112 by a conduit, and the temperature controller 112 is fluidically connected to a base portion of the container or process chamber 106 by a conduit. The apparatus 100 thus provides a substantially sealed, or sealable, closed-loop path to enable the circulation of the conductive gas through a volume of build material present in the container or process chamber 102. For simplicity it will be understood that not all elements of the apparatus 100 are shown. For example, the apparatus may additionally, comprise one or more of controllable vent valves, one-way valves, two-way valves, pressure sensors, gas sensors, pressure release valves, and the like.

In a further example, as illustrated in FIG. 1B, there is shown an apparatus 100′, that comprises a sealable process chamber 114 in which a container 102 may be inserted to allow thermal curing of a thermally curable binder agent present therein.

Elements of the apparatus 100 are controllable by a controller 120 comprising a computer or a microprocessor 122. The processor 122 is coupled to a memory 124 on which are stored machine-readable fast heating and cooling instructions 126. The instructions 126 are executable by the processor 122 to control elements of the apparatus 100 as described further below with additional reference to the flow diagram of FIG. 2.

At block 202, the controller 120 controls the gas supply 108 to supply conductive gas to the apparatus 100 to replace the gas initially present in the apparatus 100 (by ‘gas initially present in the apparatus’ should be understood the gas present in the conduits, the container or process chamber 102, the circulator 110, and the temperature controller 112). In one example, this comprises releasing, for example using a controllable electromechanics valve (not shown), a volume of conductive gas from the gas supply 108 into the conduit connected to the circulator 110 to flood the apparatus with conductive gas. In one example, replacing the gas initially present in the apparatus 100 comprises replacing at least 30%, or at least 40%, or at least 50%, or at least 60%, or at least 70%, or at least 80%, or at least 90% of the gas initially present in the apparatus 100 with the conductive gas. The higher the percentage of initial gas replaced with conductive gas, the more efficient the heating and cooling process will be.

In one example, a vacuum pump (not shown) may be used to reduce the amount of initial gas present in the apparatus 100 prior to the controller releasing the conductive gas. In another example, a purge valve may be used to expel the gas initially present to the atmosphere when the conductive gas is released into the conduits by the gas supply 108.

At block 204, the controller 120 controls the circulator 110 to circulate the gas through the conduits, the temperature controller 112, and the container or process chamber 102. In one example, the circulator 110 is to circulate the conductive gas in a single direction through the temperature controller 112, then through the container or process chamber 102. The circulator 110 may, for example, generate a positive gas pressure in the gas flow direction from the circulator 110 to the container or process chamber 102, and may generate a corresponding negative gas pressure in the gas flow direction from the container or process chamber 102 to the circulator 110.

In one example, the circulator 110 may be used to help replace the gas initially present in the apparatus 100 when the conductive gas is released into the conduits by the gas supply 108.

In one example, the container or process chamber 102 has a gas permeable base that allows the conductive gas arriving at the base portion thereof to permeate through the volume of build material 104 therein and to flow out of the top portion thereof. In one example, the permeable base prevents build material from passing through the base.

At block 206, the controller 120 controls the temperature controller 112 to heat the conductive gas to a predetermined temperature. The heated conductive gas is thus circulated through the build material 104 in the container or process chamber 102 which causes rapid heating of the build material 104. Due to the relatively high thermal conductivity of the conductive gas, the heating process is considerably faster than using thermal blankets positioned around the perimeter of the container or process chamber 102. Furthermore, use of the conductive gas enables faster heating than if just air was circulated.

In one example, the controller 120 controls the circulator 110 to generate a gas flow rate in the container or process chamber 102 that doesn't adversely mechanically disturb build material particles therein. In one example, an acceptable gas flow rate through the volume of build material may be about 15 l/min, or about 25 l/min.

At block 208, the controller 120 determines whether the temperature of the build material 104 has reached the predetermined temperature. In one example, this may be determined using a temperature sensor to measure the temperature of the conductive gas that is input to the temperature controller (i.e. the return temperature), which can be used as a proxy to indicate the temperature of the build material 104 in the container or process chamber 102. For example, the controller 120 may determine that the heating process is complete once the measured return temperature has been maintained at or above the predetermined temperature for a predetermined duration of time. In on example, the predetermined duration may be 5 minutes, 10 minutes, 20 minutes, 30 minutes, 60 minutes, although in other examples a longer or short period may be chosen. This helps ensure that all of the build material 104 has been heated to the desired temperature. In one example, the predetermined duration may be based on the volume of build material in the container or process chamber 102.

If the controller 120 determines that the predetermined temperature has not been reached, it continues to control the circulator 110 and the temperature controller 112 as described above.

Once the controller 120 determines that the heating process is complete it controls, at block 210, the temperature controller 112 to cool the conductive gas. In one example the controller 120 controls the temperature controller 112 to cool the conductive gas to a predetermined temperature or around 20 degrees, or around 30 degrees, or around 40 degrees, or around 50 degrees Celsius. The cooled conductive gas is thus circulated through the build material in the container or process chamber 102 which causes rapid cooling of the build material therein. Due to the relatively high thermal conductivity of the conductive gas, the cooling process is considerably faster than using natural cooling, and is also considerably faster than just circulating air.

At block 212, the controller 120 continues to control the circulator 110 to circulate the cooled conductive gas as described above.

At block 214, the controller 120 determines whether the cooling process is complete. In one example, this may be determined using the temperature sensor to measure the temperature of the conductive gas that is input to the temperature controller (i.e. the return temperature), which can be used as a proxy to indicate the temperature of the build material in the container or process chamber 102. For example, the controller 120 may determine that the cooling process is complete once the measured return temperature has been maintained below a predetermined cooling temperature for a predetermined duration of time. In one example, the predetermined duration may be 5 minutes, 10 minutes, 20 minutes, 30 minutes, or 60 minutes, although in other examples a longer or short period may be chosen. This helps ensure that all of the build material 104 is cooled to the cooling temperature. In one example, the predetermined duration may be based on the volume of build material in the container or process chamber 102.

If the controller 120 determines that the cooling process is not complete, it continues to control the circulator 110 and the temperature controller 112 as described above.

In one example, after the cooling process has completed, the controller 120 may replace the conductive gas in the apparatus 100 with air. This may be achieved, for example, by opening a purge valve to allow the conductive gas therein to escape to the atmosphere or to a separate (not shown) conductive gas recovery system. In another example, the controller 120 may, as shown at block 302 in FIG. 3, control the gas supply 108 to recover the conductive gas, for example, by using a compressor to return conductive gas in the apparatus 100 back to the gas supply 108.

Referring now to FIG. 4 there is shown a simplified schematic diagram of an apparatus 400 to heat the contents of a container or a process chamber 102. The apparatus 400 shares elements with the apparatus 100 shown in FIG. 1 and like reference numerals indicate like elements. The container or process chamber 102 may, when in use, comprise a volume of particulate build material 104, such as a metal, a ceramic, or a plastic, build material on which a thermally curable binder agent has been applied to define a set of three-dimensional objects 402. In one example, the volume of build material 104 is formed in a three-dimensional printer that selectively applies drops of a thermally curable binder, based on data derived from a three-dimensional object model of an object to be generated, to successively formed layers of build material. In one example, the volume of build material 104 may be formed in the container 102 by the three-dimensional printer, and in another example the volume of build material 104 may be transferred into the container 102 from a build unit of the three-dimensional printer.

In a further example, as illustrated in FIG. 4B, there is shown an apparatus 400′, that comprises a sealable process chamber 114 in which a container 102 may be inserted to allow thermal curing of a thermally curable binder agent present therein.

Elements of the apparatus 100 are controllable by a controller 120 comprising a computer or a microprocessor 122. The processor 122 is coupled to a memory 124 on which are stored machine-readable fast curing instructions 404. The instructions 404 are executable by the processor 122 to control elements of the apparatus 100 as described further below with additional reference to FIG. 5.

At block 502, the controller 120 controls the gas supply 108 to supply conductive gas to the apparatus 100 to replace the gas initially present in the apparatus 100

At block 504, the controller 120 controls the circulator 110 to circulate the gas through the conduits, the temperature controller, and the container or process chamber 102.

In one example, the circulator 110 may be used to help replace the gas initially present in the apparatus 100 when the conductive gas is released into the conduits by the gas supply 108.

At block 506, the controller 120 controls the temperature controller 112 to heat the conductive gas to a temperature at or above a temperature suitable to cure any thermally curable binder agent present in the container or process chamber 102. The heated conductive gas is thus circulated through the build material 104 in the container or process chamber 102 which causes rapid heating of the build material 104 and any binder agent therein. When binder agent present in the build material 104 cures it forms green parts 402.

In one example, the controller 120 controls the circulator 110 to generate a gas flow rate in container or process chamber that doesn't adversely mechanically disturb build material particles therein. This is to prevent deformation of the green parts during the curing process. In one example, an acceptable gas flow rate through the volume of build material may be about 15 l/min, or about 25 l/min.

At block 508, the controller 120 determines whether the curing process is complete. In one example, this may be determined using a temperature sensor to measure the temperature of the conductive gas that is input to the temperature controller (i.e. the return temperature), which can be used as a proxy to indicate the temperature of the build material in the container or process chamber 102. For example, the controller 120 may determine that the curing process is complete once the measured return temperature has been maintained above the curing temperature for a predetermined duration of time. In on example, the predetermined duration may be 10 minutes, 20 minutes, 30 minutes, 60 minutes, although in other examples a longer or short period may be chosen. This is to help ensure that all binder agent in the container or process chamber 102 is suitable cured. In one example, the predetermined duration may be based on the volume of build material in the container or process chamber 102.

If the controller 120 determines that the curing process is not complete, it continues to control the circulator 110 and the temperature controller 112 as described above.

Once the controller 120 determines that the curing process is complete it controls, at block 510, the temperature controller 112 to cool the conductive gas. In one example the controller 120 controls the temperature controller 112 to cool the conductive gas to a predetermined temperature or around 20 degrees, or around 30 degrees, or around 40 degrees, or around 50 degrees Celsius. The cooled conductive gas is thus circulated through the build material in the container or process chamber 102 which causes rapid cooling of the build material therein. Due to the relatively high thermal conductivity of the conductive gas, the cooling process is considerably faster than using natural cooling.

At block 512, the controller 120 continues to control the circulator 110 to circulate the cooled conductive gas as described above. In one example, the controller 120 controls the circulator 110 to generate a gas flow rate in container or process chamber at a higher rate than used during the curing process. This is possible since, after curing, the formed green parts have some inherent strength that allows a higher gas flow rate to be used. Furthermore, using an increased gas flow rate during the cooling phase helps to further reduce the cooling time. In one example, an acceptable gas flow rate during cooling may be at least about 15 l/min.

At block 514, the controller 120 determines whether the cooling process is complete. In one example, this may be determined using the temperature sensor to measure the temperature of the conductive gas that is input to the temperature controller (i.e. the return temperature), which can be used as a proxy to indicate the temperature of the build material in the container or process chamber 102. For example, the controller 120 may determine that the cooling process is complete once the measured return temperature has been maintained below a predetermined cooling temperature for a predetermined duration of time. In on example, the predetermined duration may be 10 minutes, 20 minutes, 30 minutes, 60 minutes, although in other examples a longer or short period may be chosen. In one example, the predetermined duration may be based on the volume of build material in the container or process chamber 102.

If the controller 120 determines that the cooling process is not complete, it continues to control the circulator 110 and the temperature controller 112 as described above.

In one example, after the cooling process has completed, the controller 120 may replace the conductive gas in the apparatus 100 with air. This may be achieved, for example, by opening a purge valve to allow the conductive gas therein to escape to the atmosphere or to a separate (not shown) conductive gas recovery system. In another example, the controller 120 may, as shown at block 602 in FIG. 6, control the gas supply 108 to recover the conductive gas, for example, by using a compressor to return conductive gas in the apparatus 100 back to the gas supply 108.

In a further example, the apparatus 700 may be used to receive a volume of build material 104 in which a set of 3D objects have been formed in a layer-by-layer manner through selective melting of portions of successive layers of build material, for example using a selective laser sintering or a fusing agent and fusing energy type three-dimensional printing system. In this example, the apparatus 700 may be used to heat the volume of build material 104 to an annealing temperature which is below the temperature at which the build material melts but at which crystallization of melted build material may continue in a controlled manner. Annealing has been shown, for example, to improve the quality of three-dimensional objects generated using selective thermal fusion techniques. In this example, the controller 120 may cause the build material 104 in the container or process chamber 102 to be heated to a suitable annealing temperature, based on the type of build material, for a predetermined period, before cooling the build material to the a cooling temperature at which the 3D objects are suitable to be removed from the volume of build material 104. In one example, the annealing period is at least 5 minutes, or at least 10 minutes, or at least 30 minutes, or at least 60 minutes.

Referring now to FIG. 7, there is shown a further example of a fast curing apparatus 700. In addition to the elements of apparatus 100, the apparatus 400 additionally includes a condenser 702 that is located, in the example shown, between the circulator 110 and the temperature controller 112. In other examples, however, the condenser 702 may be located at any other suitable position in the apparatus 700.

As shown in FIG. 8, at block 802 the controller 120 may control the condenser 702 to remove any vapors, such as binder agent solvent vapors, present in the circulated conductive gas flow. For example, as binder agent present in the container or process chamber 102 is heated by the circulating conductive gas, portions of the binder agent, such as portions of a liquid carrier vehicle, may evaporate into the gas flow. The condenser 702 thus functions to prevent these vapors from being recirculated into the build material present in the container or process chamber 102.

In one example, the binder agent can include a binder in a liquid carrier or vehicle for application to the particulate build material. For example, the binder can be present in the binding agent at from about 1 wt % to about 50 wt %, from about 2 wt % to about 30 wt %, from about 5 wt % to about 25 wt %, from about 10 wt % to about 20 wt %, from about 7.5 wt % to about 15 wt %, from about 15 wt % to about 30 wt %, from about 20 wt % to about 30 wt %, or from about 2 wt % to about 12 wt % in the binding agent.

In one example, the binder can include polymer particles, such as latex polymer particles. The polymer particles can have an average particle size that can range from about 100 nm to about 1 μm. In other examples, the polymer particles can have an average particle size that can range from about 150 nm to about 300 nm, from about 200 nm to about 500 nm, or from about 250 nm to 750 nm.

In one example, the latex particles can include any of a number of copolymerized monomers, and may in some instances include a copolymerized surfactant, e.g., polyoxyethylene compound, polyoxyethylene alkylphenyl ether ammonium sulfate, sodium polyoxyethylene alkylether sulfuric ester, polyoxyethylene styrenated phenyl ether ammonium sulfate, etc. The copolymerized monomers can be from monomers, such as styrene, p-methyl styrene, α-methyl styrene, methacrylic acid, acrylic acid, acrylamide, methacrylamide, 2-hydroxyethyl acrylate, 2-hydroxyethyl methacrylate, 2-hydroxypropyl acrylate, 2-hydroxypropyl methacrylate, methyl methacrylate, hexyl acrylate, hexyl methacrylate, butyl acrylate, butyl methacrylate, ethyl acrylate, ethyl methacrylate, 2-ethylhexyl acrylate, 2-ethylhexyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, benzyl methacrylate, benzyl acrylate, ethoxylated nonyl phenol methacrylate, ethoxylated behenyl methacrylate, polypropyleneglycol monoacrylate, isobornyl methacrylate, cyclohexyl methacrylate, cyclohexyl acrylate, t-butyl methacrylate, n-octyl methacrylate, lauryl methacrylate, tridecyl methacrylate, alkoxylated tetrahydrofurfuryl acrylate, isodecyl acrylate, isobornyl methacrylate, isobornyl acrylate, dimethyl maleate, dioctyl maleate, acetoacetoxyethyl methacrylate, diacetone acrylamide, N-vinyl imidazole, N-vinylcarbazole, N-vinyl-caprolactam, or combinations thereof. In some examples, the latex particles can include an acrylic. In other examples, the latex particles can include 2-phenoxyethyl methacrylate, cyclohexyl methacrylate, cyclohexyl acrylate, methacrylic acid, combinations thereof, derivatives thereof, or mixtures thereof. In another example, the latex particles can include styrene, methyl methacrylate, butyl acrylate, methacrylic acid, combinations thereof, derivatives thereof, or mixtures thereof.

It will be appreciated that example described herein can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine-readable storage storing such a program.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. Apparatus to process volume of particulate build material, comprising:
a sealable chamber to house a volume of particulate build material;
a gas supply to supply the chamber with a predetermined gas;
a gas circulator to circulate the gas within the volume of build material;
a temperature controller to heat the circulated gas to a predetermined heating temperature to heat the volume of build material to the heating temperature and then to cool the circulated gas to a predetermined cooling temperature to cool the volume of build material to the cooling temperature.

2. The apparatus of claim 1, wherein the gas supply is to supply a gas having a thermal conductivity greater than about 0.1 W/(m K).

3. The apparatus of claim 2, wherein the gas supply is to supply one of helium and sulfur hexafluoride.

4. The apparatus of claim 1, wherein the gas supply is to replace at least 30% of the gas initially present in the apparatus with the predetermined gas.

5. The apparatus of claim 1, wherein the chamber is to house a volume of build material on which a thermally curable binder agent has been applied, and wherein the temperature controller is to heat the circulated gas to a temperature at or above a temperature at which the binder agent cures.

6. The apparatus of claim 1, wherein the chamber is to house a volume of build material in which a set of three-dimensional objects have been formed using selective thermal fusion, and wherein the temperature controller is to heat the circulated gas to an annealing temperature for a predetermined period and then to cool the circulated gas to a predetermined cooling temperature.

7. The apparatus of claim 5, further comprising a solvent recovery module to remove binder agent solvent vapor from the predetermined gas.

8. The apparatus of claim 1, wherein the gas supply is to recover the predetermined gas.

9. A method of thermally processing a volume of build material in a process chamber comprising:
replacing the gas present in the process chamber with a conductive gas having a thermal conductivity greater than about 0.1 W/(m K);
circulating the conductive gas through the build material in the process chamber;
heating the conductive gas to a predetermined heating temperature to heat the build material to the heating temperature for a predetermined period;
cooling the conductive gas to a predetermined cooling temperature to cool the build material to the cooling temperature.

10. The method of claim 9, wherein heating the conductive gas comprises heating the conductive gas to a temperature to cause annealing of objects in the volume of build material formed using selective thermal fusion.

11. The method of claim 9, wherein heating the conductive gas comprises heating the conductive gas to a temperature at which a thermally curable binder agent in the build material cures to form a green part.

12. The method of claim 11, further comprising condensing binder agent vapors from the conductive gas.

13. The method of claim 9, further comprising recovering the conductive gas.

14. A non-transitory computer-readable medium on which is stored computer-readable instructions that when executed by a processor of a build material processing apparatus cause the apparatus to:
flood a process chamber with of one of helium or sulfur hexafluoride gas;
circulate the gas through a process chamber to house a volume of particulate build material;
heat the gas to a heating temperature to heat the build material in the process chamber for a predetermined period;
cool the gas to a cooling temperature to cool the build material in the process chamber.

15. The computer-readable medium of claim 14, further the instructions for cause the apparatus to:
heat the gas to a temperature to cause curing of a thermally curable binder agent present in the volume of build material to form a green part.
